(19) United States
(12) Patent Application Publication
(10) Pub. No.: US 2018/0027764 A1
(43) Pub. Date: Feb. 1, 2018

(54) Bag Breaker

(71) Applicant: Jack Coleman, Aledo, TX (US)

(72) Inventor: Jack Coleman, Aledo, TX (US)

(21) Appl. No.: 15/730,518

(22) Filed: Oct. 11, 2017

Related U.S. Application Data
(60) Provisional application No. 62/406,505, filed on Oct. 11, 2016.

(51) Int. Cl. A01K 5/02; B65B 69/00

(52) U.S. Cl. CPC A01K 5/0225; B65B 69/0008; B65B 69/0041

(57) ABSTRACT

A system and method for quickly opening bags of granular material into a hopper. The system utilizes a rigid frame supporting a vertical member configured to tear open the bags of granular material when the bags are placed on the frame. A grating surrounds the vertical member and helps to filter unwanted material from the hopper.

### BACKGROUND

### 1. Field of the Invention

The present invention relates generally to equipment for the efficient opening of feed bags, and more specifically to a system and method for splitting open large bags of feed for depositing into a hopper.

### 2. Description of Related Art

Feed bags typically are cut open by an external knife and then poured into a hopper or feed trough. Alternatively, feed bags are opened by pulling a built in pull string on the bag and then poured into the hopper or trough. Both methods are time intensive and require the bag to be opened and then poured. Requiring the heavy bag, of nearly 50 pounds, to be lifted until the bag is emptied. Thus, there exists significant room for improvement in the art for overcoming these and other shortcomings of conventional systems and methods for opening feed bags.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an exploded view of a bag breaker according to the present application;

FIG. 2A is a top view of the bag breaker of FIG. 1;

FIG. 2B is a front view of the bag breaker of FIG. 1;

FIG. 2C is a perspective view of the bag breaker of FIG. 1;

FIG. 2D is an end view of the bag breaker of FIG. 1; and

FIG. 3 is a perspective view of the bag breaker of FIG. 1 disposed on a feed hopper according to the present application.

While the assembly and method of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, combinations, and alternatives falling within the spirit and scope of the present application as defined by the appended claims.

### DETAILED DESCRIPTION OF THE PREFERRED EMBODIMENT

Illustrative embodiments of the system and method for breaking bags of feed open are provided below. It will of course be appreciated that in the development of any actual embodiment, numerous implementation-specific decisions will be made to achieve the developer's specific goals, such as compliance with assembly-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Hoppers for distributing grains require large amounts of materials to properly operate. In accordance with the present application, the system for breaking open bags of materials, such as deer corn and cattle cubes, is located as a lid for the hopper and sits on top of the hopper. Users grab the bag and swing the bag down onto the bag breaker, resulting in the bag being punctured by the bag breaker, thereby allowing the contents of the bag to spill or be poured through the grate into the hopper. The bag remains in one piece for easy disposal.

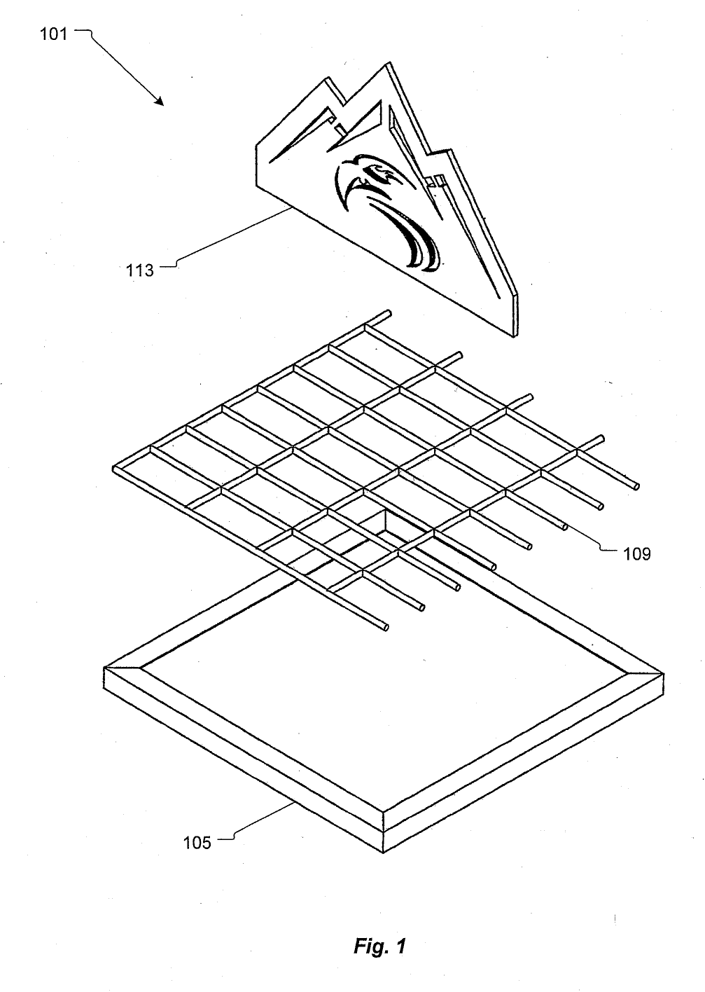

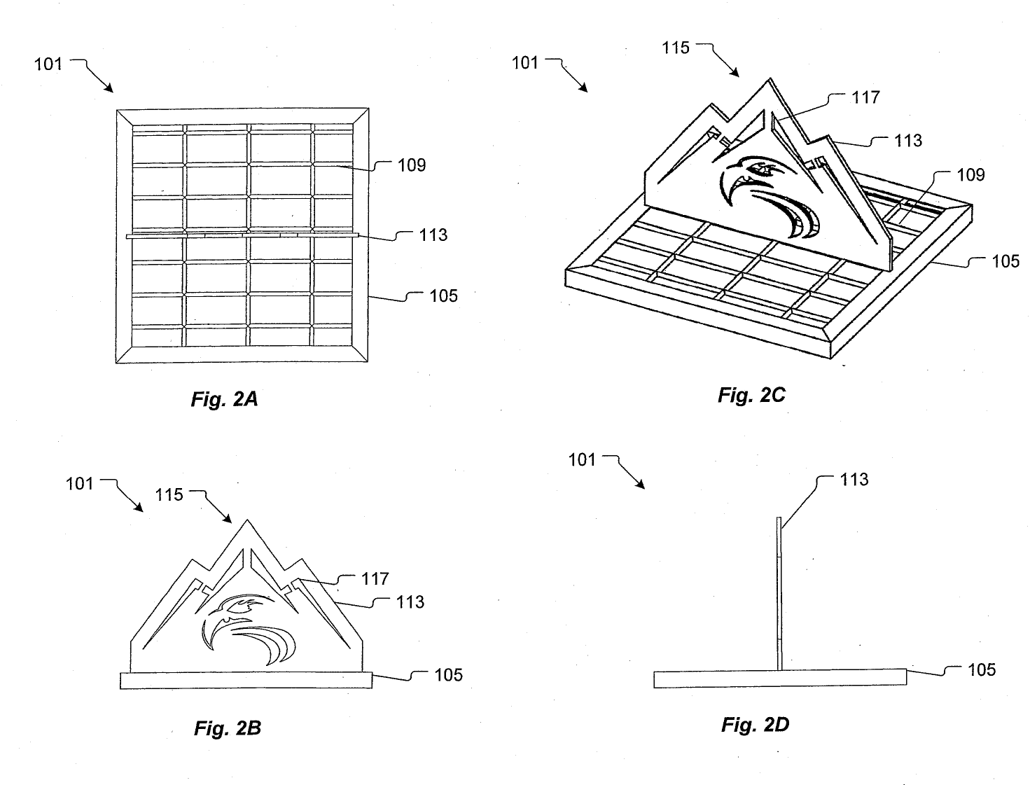

Referring to FIGS. 1-2D in the drawings, a preferred embodiment of a bag breaker 101 according to the present application is illustrated. Bag breaker 101 includes a frame member 105, a grate assembly 109, and a vertical member 113. Frame 105 supports grating 109 and vertical member 113. Frame 105 is preferably metal and acts as a lid for a hopper assembly, such as a deer feeder, located underneath or beside frame 105. Grating 109 acts to prevent debris, such as opened bags, from entering the hopper and to agitate and separate the contents of the bags as the contents enters the hopper. It is preferred that grating 109 be permanently attached to frame 105, such as by welding; however, it will be appreciated that grating 109 may be releasably attached to frame 105, such as by bolting, screwing, strapping, clamping, bonding, or clipping, etc.

Vertical member 113 is preferably rigidly attached to frame 105, such as by welding; however, it will be appreciated that vertical member 113 may be releasably attached to frame 105, such as by bolting, screwing, strapping, clamping, bonding, or clipping, etc. Alternatively, vertical member 113 may be pivotally attached to frame 105 with a locking hinge, so that the vertical member 113 may be stored flat. Vertical member 113 is preferably a thin rigid piece of metal having a plurality of jagged points along an upper edge 115. Preferably the shape of the vertical member is generally triangular with a few smaller triangular notches cut into upper edge 115 to form cutting points for cutting the bags. Furthermore, vertical member 113 may include openings 117. Openings 117 facilitate the motion of granular material once the bag has been opened by vertical member 113.

Additionally, upper edge 115 of vertical member 113 may be beveled or honed to facilitate opening of the bags of granular material. Vertical member 113 may also include, or be formed in the shape of, selected graphical indicia, textual material, and/or promotional logos. As is shown, openings 117 may form part of the graphical indicia. Vertical member 113 may also include upraised embossing and/or recessed stamping. A guard member may be utilized to cover upper edge 115 of vertical member 113 when bag breaker 101 is not in use to prevent injury to the users. The guard member is preferably shaped to conform to the shape of vertical member 113, but may be of any of a wide variety of shape sand sizes. In addition, the guard member may include additional graphical indicia, textual material, and/or promotional logos.

It will be appreciated that frame 105, grating 109, and vertical member 113 may be formed of the same materials or may be formed of different materials. In addition, although it is preferred that frame 105, grating 109, and vertical member 113 be formed of metallic materials, it will be appreciated that one or more of these components may be formed of other rigid materials, such as plastic, fiberglass, composite materials, and any other suitable materials, or combinations thereof.

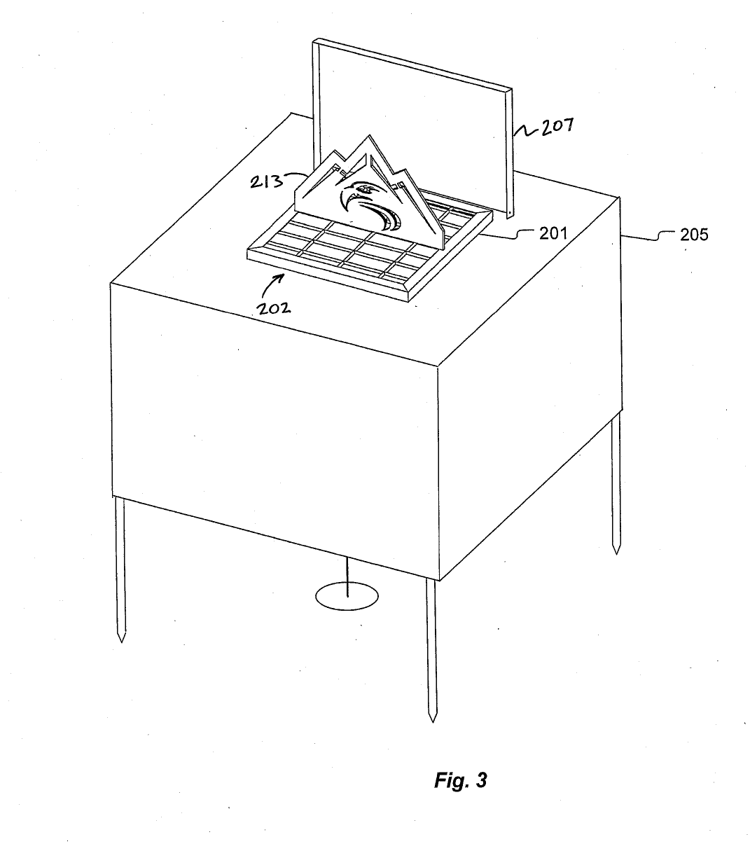

Referring now also to FIG. 3 in the drawings, a preferred embodiment of a bag breaker located on the top of a feed hopper for a deer feeder 205 according to the present, application is illustrated. As illustrated, bag breaker 201 is placed upon an opening 202 on feeder 205 in front of a pivoting lid 207 of feeder 205. When not in use, bag breaker 201 may be removed from feeder 205 or flipped upside down, so that vertical member 213 points into feeder 205. When in the upside-down position, bag breaker 201 is generally flush with opening 202 of feeder 205, thereby allowing lid 207 to be fully closed.

It is apparent that a system with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

1. A bag breaker, comprising:
a frame member;
a grate assembly coupled to the frame member;
a vertical member coupled to the grate assembly; and
at least one cutting point formed into an upper edge of the vertical member for cutting the bag.

2. The bag breaker according to claim 1, wherein the vertical member is rigidly coupled to the frame member.

3. The bag breaker according to claim 1, wherein the vertical member is hingedly coupled to the frame member.

4. The bag breaker according to claim 1, further comprising:
graphical indicia formed in the vertical member.

5. The bag breaker according to claim 4, wherein the graphical indicia formed in the vertical member include apertures through the vertical member.

6. The bag breaker according to claim 4, wherein the graphical indicia formed in the vertical member includes upraised embossing.

7. The bag breaker according to claim 4, wherein the graphical indicia formed in the vertical member includes recessed stamping.

8. The bag breaker according to claim 1, further comprising:
a guard member configured to fit over the cutting point of the upper edge.

9. A deer feeder, comprising:
a hopper assembly; and
a bag breaker comprising:
an opening in the hopper assembly;
a frame member configured to fit over the opening in the hopper assembly;
a grate assembly coupled to the frame member;
a vertical member coupled to the grate assembly; and
at least one cutting point formed into an upper edge of the vertical member for cutting the bag, whereby the contents of the bag falls into the hopper assembly.

10. The deer feeder according to claim 9, wherein the vertical member is rigidly coupled to the frame member.

11. The deer feeder according to claim 9, wherein the vertical member is hingedly coupled to the frame member.

12. The deer feeder according to claim 9, further comprising:
graphical indicia formed in the vertical member.

13. The deer feeder according to claim 9, wherein the bag breaker is configured to be stored within the hopper in an upside-down position while not in use.
